(19) United States
(12) Patent Application Publication
(10) Pub. No.: US 2012/0153087 A1
(43) Pub. Date: Jun. 21, 2012

(54) Modular Pods for Use with an Unmanned Aerial Vehicle

(75) Inventors: Daniel Ross Collette, Albuquerque, NM (US); Joseph Scott Helsing, JR., Blacksburg, VA (US)

(73) Assignee: HONEYWELL INTERNATIONAL INC., Morristown, NJ (US)

(21) Appl. No.: 12/186,693

(22) Filed: Aug. 6, 2008

(51) Int. Cl. B64C 39/00; B64D 47/08; B64D 37/02; B64C 7/00

(52) U.S. Cl. 244/23 A; 244/137.4; 244/135 R

(57) ABSTRACT

A pod for an unmanned aerial vehicle is provided that may be removed and re-attached to the vehicle. The pod comprises an outer shell, within which a variety of payloads may be carried. A first surface on the vehicle frame comprises a plurality of connects or electrical traces. The plurality of attachments are used to removably attach the pods to the first surface. Thus, a wide variety of payloads may be delivered using the same unmanned aerial vehicle, simply by removing and attaching different pods to a fixed vehicle core. These pods may be shaped so as to form part of the vehicle exterior, and when the pods are attached to the frame, they enhance the aerodynamics of the vehicle.

### GOVERNMENT RIGHTS

This invention was made with Government support under Prime Contract Number W56 HZV-05-C-0724 awarded by the United States Army. The Government may have certain rights in this invention.

### FIELD

The present invention relates generally to unmanned aerial vehicles. More particularly, the present invention relates to modular pods for use with an unmanned aerial vehicle.

### BACKGROUND

Unmanned aerial vehicles (“UAVs”) are remotely piloted or self-piloted aircraft that can carry cameras, sensors, communications equipment, or other payloads. A UAV is capable of controlled, sustained, level flight and is powered by either a jet or an engine. The UAVs may be remotely controlled or may fly autonomously based on pre-programmed flight plans or more complex dynamic automation systems.

UAVs have become increasingly used for various applications where the use of manned flight vehicles is not appropriate or is not feasible. Such applications may include military situations, such as surveillance, reconnaissance, target acquisition, data acquisition, communications relay, decoy, harassment, or supply flights. These vehicles are also used in a growing number of civilian applications, such as firefighting when a human observer would be at risk, police observation of civil disturbances or crime scenes, reconnaissance support in natural disasters, and scientific research, such as collecting data from within a hurricane.

Currently, a wide variety of UAV shapes, sizes, and configurations exist. Typically it is the payload of the aircraft that is the desired product, not the aircraft itself. A payload is what the aircraft is carrying. UAVs are the delivery system for a payload and are developed to fill a particular application and a set of requirements. As previously mentioned, there are numerous applications for which a UAV may be used. For each new application, a different type of payload may be used. Because different payloads may require different processing capabilities, or may comprise different sizes, a variation of the UAV typically must be developed for each type of payload, or a completely new aircraft typically must be designed. Designing a new aircraft or developing a variation of the current UAV in use is time-consuming and costly.

### SUMMARY

In accordance with the present invention, removable pods for an unmanned aerial vehicle are provided. The removable pods can accommodate and deliver a wide variety of payloads with little or no modification to the core vehicle itself.

A first surface on the core frame of the vehicle comprises a plurality of attachments. These attachments could be electric or mechanical connects. The plurality of attachments are used to attach pods carrying various payloads. Locking mechanisms located on the vehicle's engine supports may also attach to the pods to maintain the pods in the proper position during flight. Once the pods are connected to the vehicle frame, the vehicle flies to its destination.

After the unmanned aerial vehicle has completed the flight, the vehicle lands and the pods may be removed and unloaded. The same pods may later be re-attached to the frame. Alternatively, if new pods carrying various other payloads are desired for another operation, the new pods may be attached to the first surface of the frame. The pods may be shaped so that the leading edge of each pod enhances the aerodynamics of the vehicle while in flight. When the pods are attached to the frame, each pod forms part of the exterior surface of the vehicle and the aerodynamic shape of the pod aids in the operation of the vehicle during flight.

Pods that may be removed and exchanged from a core ducted fan gives a UAV versatility. A wide variety of payloads may be delivered using the same UAV, simply by removing and attaching different pods to the same vehicle core. This allows for greater manufacturing simplicity, as only a single type of unmanned aerial vehicle need be constructed. Costs may be decreased as well, as the storage and maintenance of a plurality of different types of unmanned aerial vehicles is no longer necessary.

This vehicle will provide intelligence on enemy activity without unduly risking the lives of human pilots or ground reconnaissance teams. For civilian use, the vehicle could be used by law enforcement for surveillance on SWAT operations.

### BRIEF DESCRIPTION OF THE DRAWINGS

Various embodiments are described herein with reference to the following drawings. Certain aspects of the drawings are depicted in a simplified way for reason of clarity. Not all alternatives and options are shown in the drawings and, therefore, the invention is not limited in scope to the content of the drawings. In the drawings:

FIG. 1 is a perspective view of a core vehicle ducted fan according to one embodiment of the invention;

FIG. 2a is a perspective view of an exemplary avionics pod;

FIG. 2b is a perspective view of an exemplary payload pod;

FIG. 2c is a perspective view of an exemplary common fuel pod;

FIG. 3 is a perspective view of four exemplary pods attached to each other having a shape in accordance with an exemplary embodiment;

FIG. 4a is a perspective view of the ducted fan of FIG. 1 with attached pods and landing feet attached; and

FIG. 4b is a side view of the ducted fan of FIG. 4a.

### DETAILED DESCRIPTION

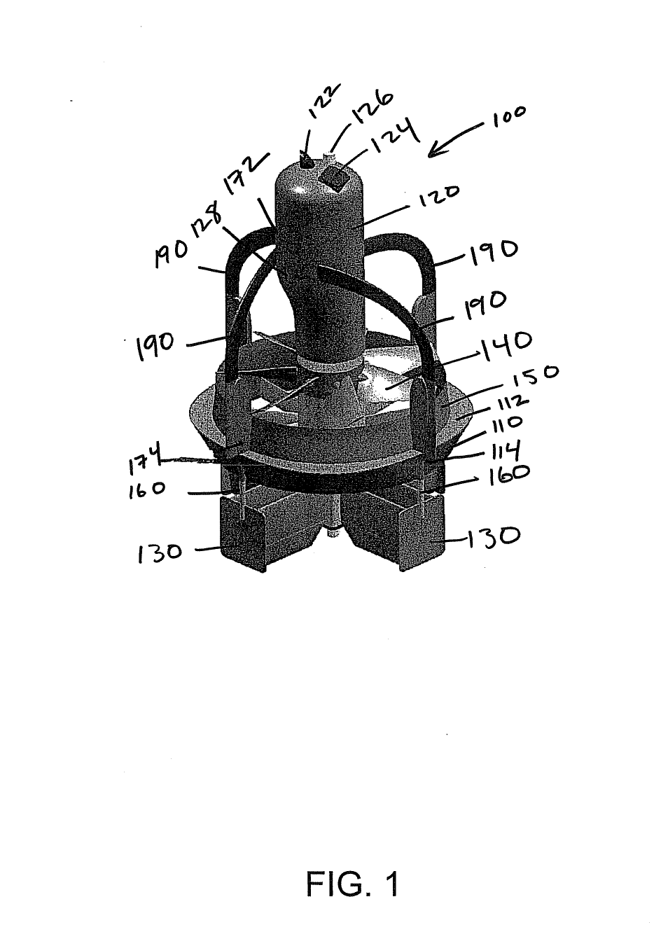

FIG. 1 depicts a perspective view of a ducted fan core 100 according to one embodiment of the present invention. Ducted fan core 100 is provided for use as an unmanned aerial vehicle.

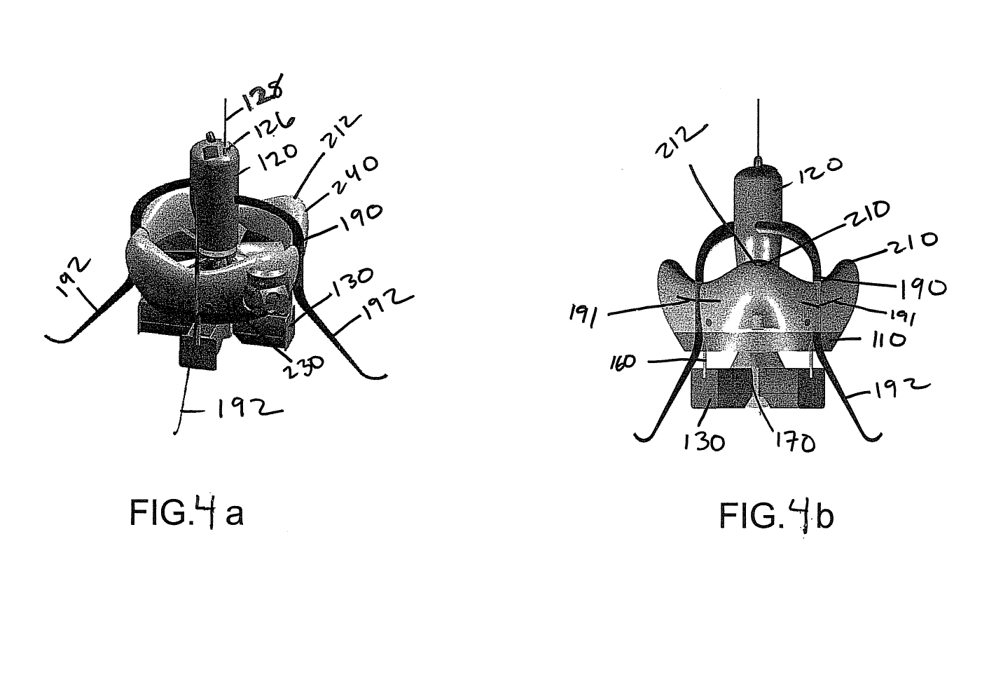

Ducted fan core 100 comprises a frame 110, an engine 120, a plurality of control vanes 130, a fan 140, a duct portion 150, a plurality of bars 160, a plurality of actuators 170 (shown in FIG. 4b), a gearbox assembly (not shown), and a plurality of engine supports 190. Engine 120 comprises an exhaust port 122, a light 124, and an antenna holder 126. Frame 110 comprises a first surface 112. Each of the plurality of engine supports 190 comprises a first end 172 and a second end 174.

Fan 140 is mounted within duct portion 150. Duct portion 150 is attached to frame 110, extending through frame 110 as shown in FIG. 1. Engine 120 may be attached to fan 140. Second end 174 of each of the plurality of engine supports 190 is attached to first surface 112 of frame 110 and first end 172 of each of the plurality of engine supports 190 is attached to engine 120. Each of the plurality of actuators 170 is attached to each of the plurality of control vanes 130. Each of the plurality of control vanes 130 is attached to frame 110 with a bar of the plurality of bars 160. Each of the plurality of control vanes is also attached to each of the plurality of actuators 170. The gearbox assembly is attached to engine 120.

Frame 110 may be manufactured as part of duct portion 150. Alternatively, frame 110 may be manufactured separately from duct portion 150 and may be attached to duct portion 150. Frame 110 may be attached to duct portion 150 with a cement or glue. Alternatively, frame 110 may be attached to duct portion 150 mechanically. Frame 110 may be manufactured from metal. Alternatively, frame 110 may be manufactured from a durable plastic or other material. First surface 112 of frame 110 may be a substantially flat surface. First surface 112 may comprise both electric and mechanical connects. First surface 112 may be a printed circuit board (“PCB”) or may have embedded electrical traces. Ribbon or edge connectors or a printed circuit board edge may be used. Alternatively, first surface 112 may comprise a fuel line quick-disconnect fitting. The plurality of engine supports 190 may be affixed to first surface 112. Frame 110 may comprise a plurality of indents 114, as shown in FIG. 1. Second end 174 of an engine support may be inserted into an indent of the plurality of indents, affixing engine support 190 to frame 110. Alternatively, frame 110 may not have any indents, and each engine support 190 may be affixed to first surface 112 of frame 110.

Engine 120 may be a turbine engine. Alternatively, engine 120 may be a number of other engine types. Engine 120 may be offset to one side of the frame center to allow for the vehicle center of gravity to be adjusted. In FIG. 1, for example, a portion 128 of engine 120 is offset to the right of the frame. Exhaust port 122 serves as an opening to allow exhaust fumes to exit the engine. Light 124 is preferably lit while the fan is in operation, and serves to alert other vehicles in the air as well as control centers of the location of the UAV. Although only one light 124 is shown, more lights, or other signaling devices, may be present on the vehicle. Additionally, the location of light 124 may be in a different location than that shown in FIG. 1. Light 124 may blink. Alternatively, light 124 may remain on throughout the vehicle's entire flight. The gearbox assembly may be mounted to engine 120.

The plurality of engine supports 190 serves to support engine 120 within frame 110. A first end 172 of each engine support may be attached to engine 120. Although four engine supports 190 are shown in FIG. 1, other numbers of engine supports may be used. Alternatively, second end 174 may be attached to a different part of frame 110.

Each bar of the plurality of bars 160 extends between the frame 110 and each of the control vanes 130, and is attached to a control vane. The plurality of bars 160 may be mechanically attached to the control vanes. The plurality of bars 160 may be made from a metal or a durable plastic. The plurality of bars 160 serves to stabilize the plurality of control vanes 130. The plurality of bars 160 may alternatively be part of the frame 110.

The UAV may be designed to be transported in a backpack. A modular lightweight load carrying equipment pack (“MOLLE”) is an army and marine corps backpack. The MOLLE pack is a fully integrated, modular load bearing system consisting of a load bearing vest with butt pack, main nick with sustainment pouches and sleeping bag compartment attached to an external frame. There is also a patrol pack, which can be used separately or combined with the main nick for added load carrying capability. MOLLE can be configured in several different variations to fit the load handling needs of the mission. The load-bearing vest is typically worn and holds pockets for magazines and hand grenades. Although ducted fan core 100 is preferably designed to fit within a MOLLE pack, ducted fan core 100 may fit into a number of other bags or backpacks. Ducted fan core 100 may be used in non-military applications, and might not be housed within a pack for those applications.

The ducted fan core 100 may weigh approximately 6-8 lbs. However, ducted fan core 100 may weigh more or less than this value, depending on materials used and size. The UAV may operate at altitudes of 100 to 500 feet above ground level, and typically the UAV will fly between 10 and 500 feet above the ground. The UAV can provide forward and down-looking day or night video or still imagery. The UAV may operate in a variety of weather conditions including rain and moderate winds. The system requires minimal operator training. Portable ground stations may be used to guide the aircraft and receive images from the cameras. The ground station can be used to program a flight path for the UAV or control it manually. The aircraft can also be equipped with electro-optical cameras for daylight operations or infrared cameras for night missions.

The UAV may run autonomously, executing simple missions such as a program or reconnaissance, or it may run under the control of a crew. The crew may comprise a pilot and sensor operators. The pilot may drive the aircraft using controls that transmit commands over a C-band line-of-sight data link, or a Ku-Band satellite link. The aircraft may receive orders via an L-3 Com satellite data link system. The pilots and other crew members use images and radar received from the aircraft to make decisions regarding control of the UAV.

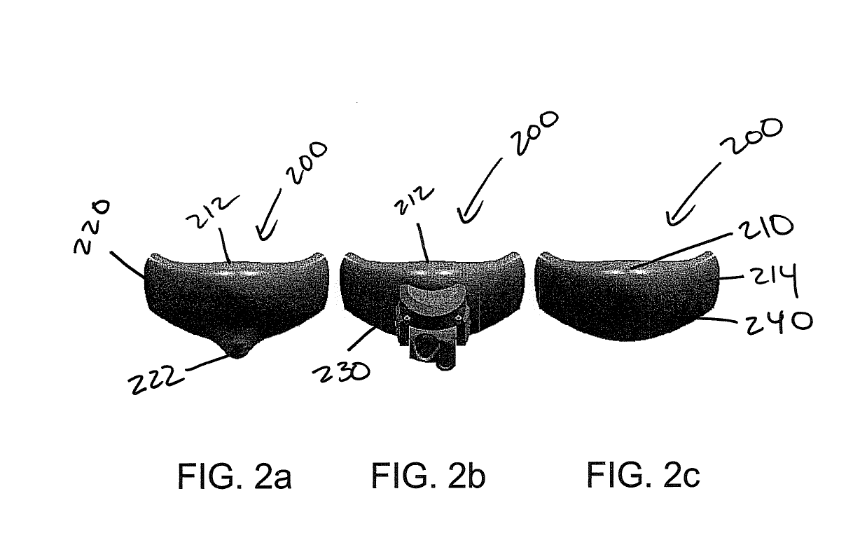

FIGS. 2a-2c illustrate exemplary pods 200 that may be attached to ducted fan core 100. Each pod may comprise a leading edge 210. A leading edge is a line connecting the forward-most points of the pod's profile; it is the front edge of the pod. When an aircraft moves forward, the leading edge is that part that first contacts the air. The leading edge may be perpendicular to the airflow, in which case it is called a straight wing. The leading edge may meet the airflow at an angle, in which case it is referred to as a swept wing. Leading edge 210 of pod 200 may be shaped to enhance the aerodynamic aspects of the UAV. For example, leading edge 210 may comprise a convex curve 212. When pod 200 is attached to frame 110 and the unmanned aerial vehicle is flying, air will hit leading edge 210 and flow in a desired direction so as to enhance the airspeed of the vehicle and minimize the obstruction of air hitting the vehicle. In addition, the shape of each pod 200 may be such that when the pods are affixed to frame 110, the pods form an exterior portion of the UAV. A portion of the pod may comprise an indent (not shown) on the internal surface of outer shell 214 near the pod base so that when the pod base is attached to first surface 112, the indented portion of the pod sits against duct portion 150 and the non-indented portion of the internal surface is flush with duct portion 150. This allows for pod 200 to be integral with duct portion 150. Air may flow over both the external surface of outer shell 214 and the internal surface of outer shell 214. The internal surface of outer shell 214 may be shaped so that as air hits the leading edge, the air flows down and is guided along the internal surface to then impact fan 140.

Each pod 200 is a module. A module is a self-contained component of a system, which has a well-defined interface to the other components. Pods 200 can be interchanged as units without disassembly of the pod itself Pod 200 may comprise an outer shell 214 and an interior (not shown). The interior of each pod 200 functions as a container, and contains a payload. The payload, or carrying capacity, of each pod may vary. In an unmanned aerial vehicle, the payload may carry equipment or instruments, for example. More specifically, for example, pod 200 may contain cameras, fuel, gas, or electronics. A variety of pods may be used with a UAV. FIG. 2a illustrates a perspective view of an avionics pod 220. Avionics pod 220 may be used to carry avionics equipment, such as cameras, a laser designer, a range finder, or supplies. Avionics pod 220 may comprise an extension 222 to accommodate mission specific electronics. Payload pod 230 may be used to carry integrated flight management for the purpose of an application designed for the pod, i.e. surveillance. Common fuel pod 240 may be used to carry fuel. Pod 200 may carry payloads comprising cameras for the purpose of taking photographs or to videotape the ground below the vehicle's flight path.

Pod 200 is not necessarily limited for use with an unmanned aerial vehicle. Pod 200 may also be used with a terrestrial vehicle. For example, after pod 200 is detached and removed from the UAV, pod 200 may be attached to a terrestrial vehicle before arriving at the desired destination. Pod 200 may be attached to the terrestrial vehicle using the same attachment mechanisms as used for attachment to a UAV.

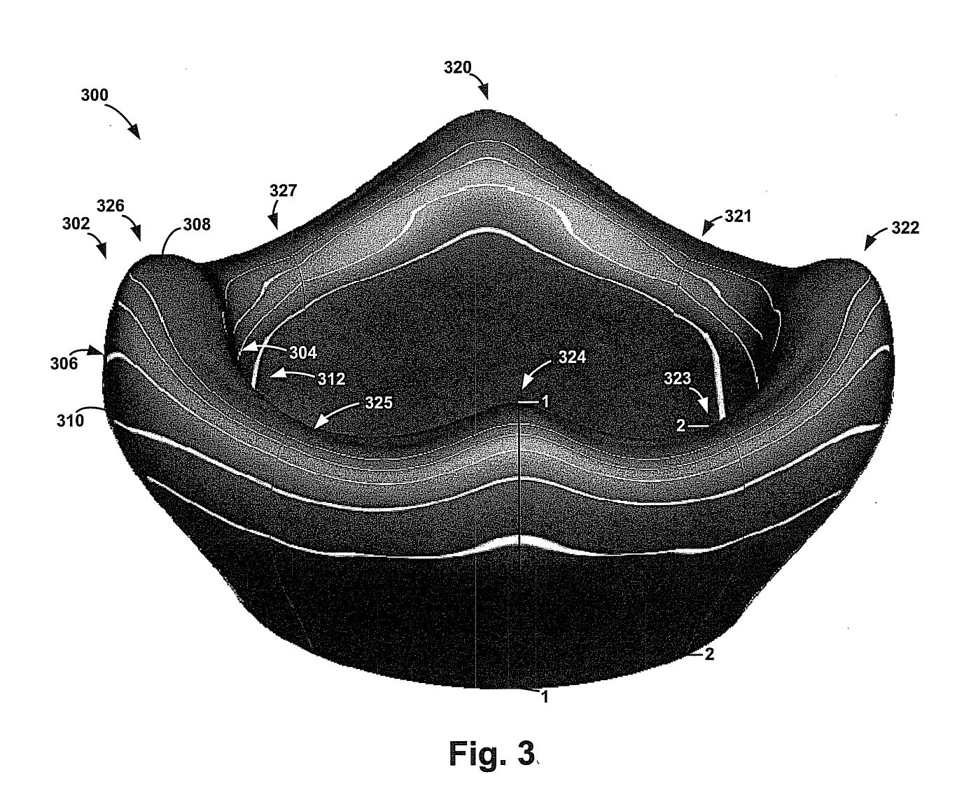

Four attached pods having a shape in accordance with an exemplary embodiment may be described by reference to FIG. 3. Although FIG. 3 shows four pods attached to each other, when attached to a UAV the pods may instead be attached to engine supports 190, as shown in FIG. 4. When attached as shown in FIG. 3, pods 300 form a circumference. As depicted in FIG. 3, each pod 300 has a lip 302. Lip 302 comprises an internal lip portion 304 and an external lip portion 306. A cross-section of a pod may be taken at the line depicted by 1-1, which is a cross-section at a wide portion of pod 300. A cross-section could also be taken at the line depicted by 2-2, which is a cross-section at a narrow portion of the pod. Alternatively, a cross-section could be taken at any other point along the circumference of the attached pods.

Each pod cross-section includes a lip highlight location 308 and a location 310 of maximum radial distance. Lip highlight location 308 is the forward-most point on lip 302 in the axial direction. The axial height of lip highlight location 308 may vary for a plurality of cross-sections. The location 310 of maximum radial distance is the point of maximum radial thickness in the cross-section. The radial distance of the location 310 of maximum distance may vary for a plurality of cross-sections. When the pods are designed so that when assembled together as shown in FIG. 3, there are four wide cross-sections separated approximately 90 degrees from each other along the circumference and narrow cross-sections between the wide cross-sections. This design may be referred to as the claw-shaped design, as shown in FIG. 3. However, the pods are not limited to the claw-shaped design, and a number of other pod designs may be used. As an example, the pods may be uniform in height, comprising a raised shape design. The shape of the pods may depend on the payload required, and may vary in order to suit the payload in use. In the claw-shaped design, each pod has a peak such that the assembly of four pods has a plurality of peaks 320, 322, 324, 326 and a corresponding plurality of troughs 321, 323, 325, 327. Specific values associated with each cross-section and location may be varied in accordance with desired pod size, desired aerodynamic characteristics, and other design parameters. Additionally, the number of peaks and troughs may vary depending on design parameters and desired air flow characteristics. In a preferred embodiment, the axial height of highlight 308 may be biased toward the troughs in order to reduce blockage of flow by the peaks in forward flight.

Adjusting the design of peaks 320, 322, 324, 326 and troughs 321, 323, 325, 327 may be useful for adjusting the center of gravity of a ducted fan UAV. The center of gravity, as well as the control authority, need to be maintained on a UAV. Pods 300 are arranged and designed to maintain both the center of gravity and the control authority. Control vanes 130 need control authority in order to properly direct the vehicle and maintain an upright position during flight.

The internal lip portion 304 is the portion of the lip that extends from lip highlight location 308 to the location 312 where pod 300 is attached to the duct. The shape of the internal lip portion 304 is defined by the curve between locations 308 and 312. When pod 300 is attached to the core UAV, location 312 is preferably flush with the duct wall, so that internal lip portion 304 becomes integral with the duct wall. Internal lip portion 304 may be inset to accommodate the wall of duct portion 150.

The external lip portion 306 extends from the lip highlight location 308 to the location 310 of maximum radial thickness. The shape of the external lip portion 306 is defined by the curve between locations 308 and 310.

FIG. 4a is a perspective view of the ducted fan core of FIG. 1 in the operating position. FIG. 4b shows a side view of the ducted fan core of FIG. 4a. In FIG. 4a, pods 200 are attached to first surface 112 of frame 110. In addition to the attachment of the pods to first surface 112, engine supports 190 may provide further attachment support. For example, each of engine supports 190 may comprise a butterfly lock 191 that slides into corresponding grooves on each pod and latches to lock each pod into place during flight. Alternatively, pins or a variety of other support or locking mechanisms may be used. Additionally, landing feet 192 have been attached to the plurality of engine supports 190. Landing feet 192 serve to raise the UAV from the ground, enabling control vanes 130 to move so that the vehicle may be prepared for take off. Landing feet 192 also serve to land the vehicle once the vehicle has reached its final destination, protecting the parts that make up the core of the vehicle. Landing feet 192 may be removably attached to plurality of engine supports 190. Alternatively, landing feet 192 may be attached to another part of ducted fan core 100.

An antenna 128 may lie within antenna holder 126, and may allow the UAV to receive and transmit signals. Unmanned aerial vehicle may be remotely controlled, or may be self-controlled for a particular journey. Once the vehicle has launched, control vanes 130 receive signals to control the direction of flight. Control vanes 130 move in response to the signals, altering the course of airflow from fan 140, which guides the direction of flight for the vehicle. As the UAV flies, air contacts leading edge 210 of pods 200, flowing around the surface of each pod. Once the vehicle has reached its final destination (e.g. returned to base), landing feet 192 contact the ground. The pods 200 may then be removed and the payloads may be unloaded. The pods that were removed may then be re-attached to first surface 112 of frame 110. Alternatively, new pods may be attached to first surface 112 of frame 110.

1. A module for an unmanned air vehicle, the module comprising:
an outer shell, comprising:
an external surface;
an internal surface;
a base, wherein the base comprises a plurality of attachments configured to removably attach the outer shell to a frame of the unmanned air vehicle; and
a leading edge; and
an interior within the outer shell, wherein the interior is configured to contain a payload.

2. The module of claim 1, wherein the leading edge forms a convex curve.

3. The module of claim 1, wherein the outer shell is configured such that when the base is attached to the frame, the internal surface is flush with a duct of the unmanned air vehicle.

4-6. (canceled)

7. The module of claim 1, wherein the plurality of attachments comprises gas connects.

8. The module of claim 1, wherein the plurality of attachments comprises electric connects.

9. The module of claim 1, wherein the payload comprises at least one camera.

10. The module of claim 1, wherein the payload comprises fuel.

11. An unmanned aerial vehicle comprising:
a ducted fan core comprising a duct portion and a plurality of attachments; and
a plurality of payload pods configured to be attached to the ducted fan core via the plurality of attachments, wherein each of the plurality of payload pods comprises:
a base, and
a lip comprising an internal lip portion and an external lip portion,
wherein each payload pod defines a perimeter, and a plurality of cross-sections along the perimeter,
wherein the internal lip portion is curved so as to follow a circumference of the duct portion, and
wherein at least two cross-sections of the plurality of cross-sections have a different shape.

12. The unmanned aerial vehicle of claim 11, wherein at least one pod of the plurality of payload pods further comprises a payload.

13. The unmanned aerial vehicle of claim 11, wherein the plurality of payload pods are configured to be removably attached to the ducted fan core via the plurality of attachments.

14. The unmanned aerial vehicle of claim 11, wherein when at least one pod of the plurality of payload pods is attached to the ducted fan core, the at least one pod forms a portion of an external surface of the unmanned aerial vehicle.

15. The unmanned aerial vehicle of claim 11, wherein each cross-section of each pod of the plurality of payload pods has a lip highlight location comprising an axial height and a location of maximum radial thickness having a radial distance from a center of the unmanned aerial vehicle.

16. The unmanned aerial vehicle of claim 15, wherein, for at least one pod of the plurality of payload pods, the radial distance from the center of the unmanned vehicle varies for the plurality of cross-sections around the perimeter of the at least one pod.

17. The unmanned aerial vehicle of claim 11, wherein the plurality of attachments comprises gas connects.

18. The unmanned aerial vehicle of claim 11, wherein the plurality of attachments comprises at least one of mechanical connects or electric connects.

19. The unmanned aerial vehicle of claim 11, wherein at least one pod of the plurality of payload pods comprises an integrated sensor.

20. An unmanned aerial vehicle comprising:
a ducted fan core; and
a plurality of pods, wherein each pod of the plurality of pods comprises:
a base; and
a leading edge having an axial height and a plurality of radial locations having radial distances from a center of the ducted fan core;
wherein when the pods are attached to the ducted fan core, the pods form a circumference around the ducted fan core;
wherein the axial height varies for a plurality of cross-sections of each pod such that when the pods are attached to the ducted fan core, there are a plurality of peaks along the circumference and a plurality of troughs along the circumference; and
wherein the base of each of the plurality of pods is removably attachable to the ducted fan core.

21. The unmanned aerial vehicle of claim 11, wherein when the base of each pod of the plurality of pods is attached to the ducted fan core, an internal surface of the base is flush with the duct portion.

22. The unmanned aerial vehicle of claim 11, wherein an internal surface of each pod of the plurality of pods is shaped so that air flows along the internal surface and strikes the ducted fan core.

23. The unmanned aerial vehicle of claim 20, wherein the duct fan core comprises a duct wall, and each pod of the plurality of pods comprises a lip comprises an internal lip portion and an external lip portion, wherein when the pod is attached to the duct fan core, the internal lip location is integral with the duct wall.
